(19) United States
(12) Patent Application Publication
(10) Pub. No.: US 2004/0031464 A1
(43) Pub. Date: Feb. 19, 2004

(54) Internal combustion engine with at least one cylinder and a reciprocating piston which can move therein

(76) Inventors: Stefan Arndt, Stuttgart (DE); Hans Schlembach, Muehlacker (DE); Ulrich Brenner, Moeglingen (DE); Udo Sieber, Bietigheim (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,770

(22) PCT Filed: Nov. 20, 2001
(86) PCT No.: PCT/DE01/04299

(30) Foreign Application Priority Data
Nov. 21, 2000 (DE) 100 57 630.3

(51) Int. Cl. F02B 3/00

(52) U.S. Cl. 123/298

(57) ABSTRACT

There are internal combustion engines with at least one cylinder and a reciprocating piston that can be moved in this cylinder, with a cylinder head associated with the cylinder, with a direct injector, and optionally with an electric spark plug, and with a device that is disposed in a stationary fashion on or in the cylinder head and is for absorbing electrical energy so that a surface of the device can be heated and used to at least partially vaporize fuel and at least partially for encouraging the ignition of the fuel/air mixture, particularly when the relevant internal combustion engine needs to be started, for example when cold.

The invention proposes embodying a device for electrical energy absorption in such a way that it can move along with the reciprocating piston and can be at least indirectly supplied with electrical energy. To this end, the device is associated with an ohmic resistance (10) that can be moved along with the reciprocating piston (4) and is connected to the secondary winding (9) of a transformer to form a circuit, where an alternating magnetic field that is supplied to the secondary winding (9) is generated by means of a primary winding (8) that is supported by the cylinder head (5).

The device equipped with the ohmic resistance (10) is used to at least partially vaporize fuel injected by means of the injector (6) in order to facilitate the starting of the internal combustion engine and to reduce the HC content of the combustion gases.

The invention is based on an internal combustion engine as generically defined by the preamble to claim 1.

### PRIOR ART

The reference DE 19 06 585 A1 has disclosed an internal combustion engine with a reciprocating piston, whose reciprocating piston base has a trough-shaped heat pipe incorporated into it so that a combustion chamber, which is axially defined by the reciprocating piston in a variable fashion, for the sake of an improved carburetion and combustion of fuel, assumes a desired high temperature, but this temperature is only at most exceeded by an insignificant amount. Another exemplary embodiment of an internal combustion engine from this reference DE 19 06 585 A1 has a heat pipe, which is incorporated into the cylinder head and can be electrically heated by means of an electrical resistance in the form of a coil. The electric heating offers the advantage that the heat pipe already has an elevated temperature, for example even before a first injection, so that the fuel to be injected can be at least partially vaporized and therefore is more readily combustible. In this respect, this heat pipe can also be used as a starting aid for the internal combustion engine. The exemplary embodiment with the trough-shaped heat pipe on the reciprocating piston is not electrically heated and is only effective when heated through combustion of the fuel/air mixture. In this respect, the heat pipe that is supported by the reciprocating piston is not a starting aid.

The reference DE 27 15 943 A1 has disclosed another internal combustion engine. It has an ignition chamber that communicates with a so-called main combustion chamber and whose wall is partially embodied as a heat pipe and is equipped, for example, with an electric resistance heating in order to encourage fuel combustion.

The reference US 45 86 075 A has disclosed another ignition chamber, which is temperature-controlled like a heat pipe and has ignition aids that can be electrically heated. An injector for either diesel fuel or gasoline feeds into the ignition chamber. If the ignition chamber is used for gasoline, then the ignition chamber is provided with a spark plug. The fact that the communication of the ignition chamber with the main combustion chamber through narrow conduits is encumbered with flow resistances and corresponding energy losses can be perceived as disadvantageous. These energy losses cause fuel to be consumed. Therefore an internal combustion engine equipped with direct fuel injection is frequently preferable.

The reference DE 3 117 144 A1 has disclosed an internal combustion engine that operates with direct injection, which has a number of cylinders and a corresponding number of reciprocating pistons. This internal combustion engine is depicted as a four-stroke engine with six cylinders and is equipped for starting without a customary starter motor that turns the crankshaft. The starting is initiated by selecting a cylinder whose reciprocating piston, when a rotation of the crankshaft is just beginning, is the one that is disposed in a working stroke. The start takes place through the direct injection of fuel into the selected cylinder and through electrical ignition of the fuel. Since due to the stationary state of the reciprocating piston, particularly when the internal combustion engine is cold, a mixture of fuel and available air in the cylinder can be disadvantageously lacking, there are times when a starting of the internal combustion engine is unsuccessful.

### ADVANTAGES OF THE INVENTION

The internal combustion engine with the characterizing features of claim 1, has the advantage that before a direct injection of fuel into the selected cylinder, a surface of the reciprocating piston oriented toward the combustion chamber can be heated to a temperature such that at least a part of this fuel that comes into contact with the surface vaporizes and mixes with air and can therefore be electrically ignited.

Advantageous modifications and improvements of the internal combustion engine disclosed in claim 1 are possible by means of the measures taken in the dependent claims.

The characterizing features of claim 2 disclose an exemplary embodiment that can be produced, for example, by using electric resistance wire.

The characterizing features of claim 3 and claim 4 disclose the advantage that the supplying of the ohmic resistance with heating current without using contact strips and sliding contacts or other elements that bridge over variable distances and thereby conduct electricity is achieved by electrical engineering means. This benefits functional reliability even when the internal combustion engine is operated over long periods of time.

The characterizing features of claim 5 offer the advantage of permitting a low-loss inductive transmission of electrical energy to the ohmic resistance.

The characterizing features of claim 6 result in a technically simple and therefore reasonably priced placement of the magnetic flux conductor.

The characterizing features of claim 7 result in an alignment of the involved elements that is favorable for the energy transmission.

The characterizing features of claim 8 improve the concentration of magnetic flux lines in the vicinity of the mobile secondary winding, which increases the efficiency of the electrical energy transmission.

The characterizing features of claim 9 offer an alternative to the inductive transmission of heating current according to claims 2 to 8.

The characterizing features of claim 10 offer another alternative, which avoids the use of sliding strips and sliding contacts according to claim 9 and in this way permits a degree of reliability to be achieved that is comparable to that of the inductive transmission of heating current.

### DRAWINGS

Two exemplary embodiments of the internal combustion engine according to the invention are shown in the drawings and will be explained in detail below.

FIG. 1 shows a schematic representation of a stationary primary winding, a mobile secondary winding, and an ohmic resistance associated with the secondary winding,

FIG. 2 shows a three-dimensional arrangement in a reciprocating piston that coincides with the principle of FIG. 1,

FIG. 3 shows another exemplary embodiment, and

FIG. 4 shows another schematic representation.

### DESCRIPTION OF THE EXEMPLARY EMBODIMENTS

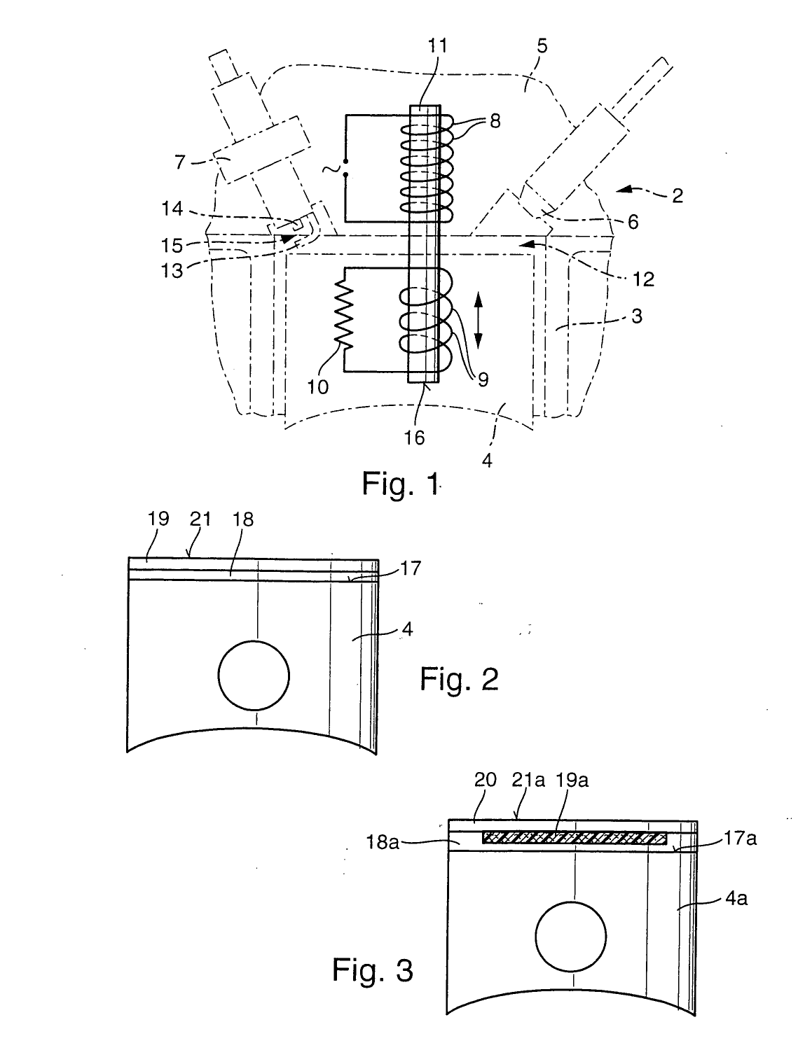

FIG. 1 is a schematically representation of a detail of the internal combustion engine 2 according to the invention, which in this instance is a spark ignition engine. Dot-and-dash lines are used to depict a cylinder 3, a reciprocating piston 4 that can be moved in this cylinder, a cylinder head 5, an injector 6, an electric spark plug 7, a primary winding 8, a secondary winding 9, an ohmic resistance 10, and a magnetic flux conductor 11.

The cylinder 3, the reciprocating piston 4, and the cylinder head 5 enclose a combustion chamber 12 whose volume varies as a function of movements of the reciprocating piston 4. The injector 6 feeds into this combustion chamber 12 and is oriented toward the reciprocating piston 4. The injector 6 can be supplied in a manner that is not shown, by a device that supplies pressurized fuel, for example gasoline. The electric spark plug 7 can be selected, for example, from the prior art and has electrodes 13 and 14, which protrude into the combustion chamber 12 and constitute an ignition spark path 15 between themselves. Alternatively, the injector 6 could also be equipped to inject diesel fuel in order to operate the internal combustion engine using the diesel process. Instead of the spark plug 7, a glow plug could then be installed.

For the sake of simplicity, the drawings do not show at least one gas inlet valve of the known type and at least one gas outlet valve of the known type. The provision of one gas inlet valve and one gas outlet valve turns the internal combustion engine 2 into a four-stroke engine. The invention, however, is not limited to use in a four-stroke engine, but can also be used in combination with a two-stroke engine. The embodiment of an internal combustion engine as a two-stroke engine is widely known so that for the sake of simplicity, an extensive depiction can be dispensed with here.

The primary winding 8 is affixed in the cylinder head 5, with its winding axis preferably or at least essentially parallel to an imaginary longitudinal axis of the cylinder 3, and can be supplied with alternating current from an alternating current source that is not shown. As is known, such an alternating current source can be comprised of a direct current source and a subsequent d.c.-a.c converter.

The secondary winding 9 is preferably mounted in a vibration-proof manner in the reciprocating piston 4 in an equiaxial alignment to the primary winding 8. The ohmic resistance 10 is connected in an electrically conductive manner to the secondary winding 9 and in this way constitutes an electrical circuit with the secondary winding 9.

When the primary winding 8 is supplied with alternating current from the alternating current source that is not shown, it produces magnetically alternating fields, which when the secondary winding 9 is close enough to the primary winding 8, generates alternating voltages and therefore also alternating currents in the secondary winding 9 thanks to the above-mentioned electrical circuit. At least in the vicinity of the cylinder head 5 and therefore inside the primary winding 8, the magnetic flux conductor 11 is embodied in the form of a rod-like component in order to allow the greatest possible amount of the product of amperes times number of windings that the primary winding 8 can generate to be converted into magnetic flux and then converted into voltage and current intensity by the secondary winding 9. The length of this magnetic flux conductor 11 can be chosen in such a way that the magnetic flux conductor 11 protrudes out of the cylinder head 5 into the combustion chamber 12 and reaches into the secondary winding 9, for example with a free end 16, at least when the reciprocating piston 4 is disposed in or near the end position close to the cylinder head. This is clearly depicted in FIG. 1 because the rod-like magnetic flux conductor 11 passes through the secondary winding 9 over its entire length and protrudes out from the secondary winding 9 with its free end 16.

In FIG. 2, the reciprocating piston 4 is shown in a simplified manner in the form of an outside view, with a reciprocating piston top 17, which has a flat, planar boundary in the exemplary embodiment, but can also have a differently shaped boundary. An insulating layer 18 is attached to the reciprocating piston top 17 and a plate-like heating element 19 is attached to the insulating layer 18. The heating element 19 contains the ohmic resistance 10. It is left up to the discretion of the electrical heating specialist to design the heating element 19 and its ohmic resistance 10 and to electrically connect them to the secondary winding 9. The insulating layer 18 is embodied as a thermal resistance between the heating element 19 and the reciprocating piston top 17 in such a way that a large portion of the electrical energy supplied by the heating element 19 serves to heat the heating element 19, i.e. less of this electrical energy migrates into the reciprocating piston 4.

FIG. 3 shows an outside view of an alternative reciprocating piston 4a, whose reciprocating piston top 17a once again has an insulating layer 18a attached to it. In the example according to FIG. 3, a heating element 19a is incorporated into the insulating layer 18a and is covered toward the cylinder head 5 by a heat-emitting cover 20. The cover 20 is comprised of a favorably thermally conductive material so that heat generated in the heating element 19 is predominantly absorbed by the cover 20 and therefore less of this heat generated by the heating element 19 passes through the insulating layer 18a to heat the reciprocating piston 4a.

It is clear that by supplying current to the heating element 19, 19a, a surface 21, 21a associated with the respective cylinder head 5 experiences a temperature increase, as a result of which the respective surface 21, 21a assumes a temperature higher than the respective temperature of the reciprocating piston 4, 4a and of the respectively associated cylinder 3. The temperatures of the surfaces 21, 21a, which are higher than those of the reciprocating pistons 4, 4a and the cylinders 3, can be used for a number of things, namely on the one hand, can be used as a starting aid for an internal combustion engine with a conventional starter motor and on the other hand, can be used as a means for reducing hydrocarbon percentages in exhaust gas when the engine has not yet reached operating temperature, and can also be used as a fuel vaporization device for the purpose of permitting the engine to be reliably started without a starter motor by means of a starting procedure that is described for a multi-cylinder spark ignition engine in the reference DE 31 17 144 A1 mentioned at the beginning of the specification. It is also clear that when they are used as a starting aid, the use of the heatable surfaces 21, 21a in a starting process that employs a starter motor offers the advantage that the starter motor can be of a less heavy-duty design. This naturally brings the advantage that once electrically heated, the surfaces 21, 21a can then be used for vaporizing fuel, which improves combustion processes and thus reduces the percentage of unspent fuel in the exhaust gas.

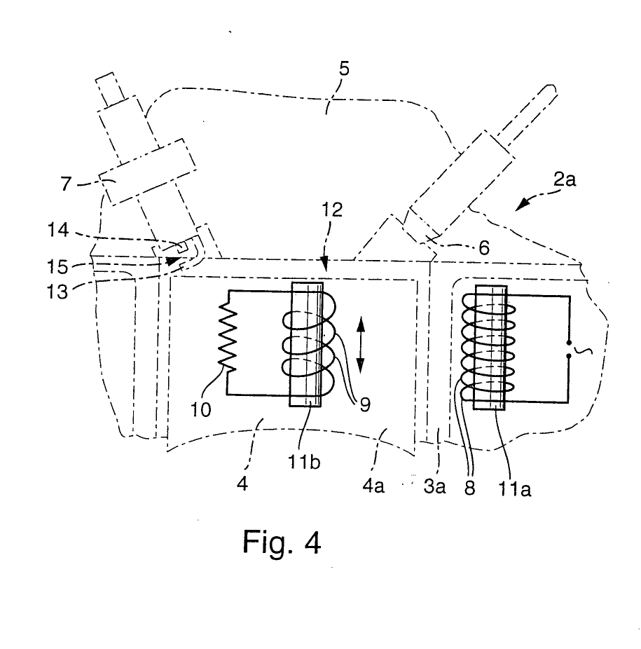

FIG. 4 shows an exemplary embodiment of an internal combustion engine 2a alternative to the exemplary embodiment according to FIG. 1. The difference in relation to the exemplary embodiment according to FIG. 1 lies in the fact that a primary winding 8 is now disposed next to the movement path of the reciprocating piston 4 and therefore in the vertical vicinity of a cylinder 3a and is somehow fastened to this cylinder. In this connection, the primary winding 8 can have a magnetic flux conductor 11a and the secondary winding 9 can have a separate magnetic flux conductor 11b.

In principle, the invention can be transferred from the spark ignition engine described to a diesel engine.

Alternative to the arrangement of the primary winding 8 and the secondary winding 9, at least one electrically conducting sliding strip and a sliding contact oriented toward it can be provided, for example on the reciprocating piston. Another alternative would be comprised in placing a microwave transmitter on or in the cylinder head and placing a layer of microwave-sensitive material on the reciprocating piston in order to convert microwaves into thermal energy.

1. An internal combustion engine (2) with at least one cylinder (3) and a reciprocating piston (4) that can move in this cylinder, with a cylinder head (5) associated with the cylinder (3), with a direct injector (6), and with a device that is fastened on or in the reciprocating piston (4, 4a) and has a surface (21, 21a), which is oriented toward the cylinder head (5) and whose temperature can be controlled, characterized in that the device is equipped to absorb electrical energy at least indirectly in such a way that the temperature-controlled surface (21, 21a) assumes a temperature greater than a temperature of the cylinder (3).

2. The internal combustion engine according to claim 1, characterized in that the device (8, 9) has an ohmic resistance (10).

3. The internal combustion engine according to claim 2, characterized in that the ohmic resistance (10) is connected to a secondary winding (9), that the secondary winding (9) is disposed in the reciprocating piston (4, 4a), and that a primary winding (8) that can be supplied with alternating current is disposed resting in the cylinder head (5).

4. The internal combustion engine according to claim 2, characterized in that the ohmic resistance (10) is connected to a secondary winding (9), that the secondary winding (9) is disposed in the reciprocating piston (4, 4a), and that a primary winding (8) that can be supplied with alternating current is disposed resting against the cylinder (3).

5. The internal combustion engine according to claim 3, characterized in that the primary winding (8) is associated with a magnetic flux conductor (11).

6. The internal combustion engine according to claim 5, characterized in that the magnetic flux conductor (11) is embodied in the form of a rod and is encompassed by the primary winding (8).

7. The internal combustion engine according to claim 6, characterized in that the rod-like magnetic flux conductor (11) is aligned essentially parallel to the longitudinal axis of the cylinder (3) and that the secondary winding (9) is aligned equiaxially with the rod-like magnetic flux conductor (11).

8. The internal combustion engine according to claim 7, characterized in that the rod-like magnetic flux conductor (11) protrudes from the cylinder head (5) in such a way that it protrudes at least sometimes into the secondary winding (9) that can be moved by the reciprocating piston (4, 4a).

9. The internal combustion engine according to claim 2, characterized in that at least one sliding strip that carries heating current is embedded into the cylinder (3) and at least one sliding contact that is oriented toward the sliding strip is disposed on the reciprocating piston.

10. The internal combustion engine according to claim 1, characterized in that for indirect absorption of electrical energy, the device has a layer comprised of a microwave-sensitive material supported by the reciprocating piston and that a microwave transmitter is placed in the vicinity of the cylinder head (5).
